(19) United States
(12) Patent Application Publication
(10) Pub. No.: US 2021/0039740 A1
(43) Pub. Date: Feb. 11, 2021

(54) Telescopic Suspension Fork Leg and Telescopic Fork Provided Therewith

(71) Applicant: KTM AG, Mattighofen (AT)

(72) Inventor: Hannes Fellner, Zipf (AT)

(21) Appl. No.: 16/963,981

(22) PCT Filed: Jan. 3, 2019
(86) PCT No.: PCT/EP2019/050114

§ 371 Date: Jul. 22, 2020

(30) Foreign Application Priority Data
Jan. 24, 2018 (DE) 10 2018 101 548.8

(51) Int. Cl. B62K 25/08; F16F 9/06

(52) U.S. Cl. CPC B62K 25/08; F16F 9/067; B60G 2300/12; B60G 2202/24; B60G 2206/40

(57) ABSTRACT

A telescopic suspension fork leg (1, 43) is provided, with an inner tube (2) and an outer tube (3) and a damping device (7) and a spring device (5), which is arranged inside a first chamber (5) formed in the inner tube (2) or outer tube (3) and is supported with respect to a second chamber (6) formed by the damping device (7), and the telescopic suspension fork leg (1, 43) is designed to receive a damping fluid, the damping device (7) comprising a piston (9) supported on a piston rod (8) and having an upper and a lower piston surface (10); 11) and the piston (9) is displaceable within a damping tube (13) arranged substantially concentrically to the inner tube (2) and the damping tube (13) is surrounded by an annular chamber (14) arranged substantially concentrically to the damping tube (13) and a gap space (15) is formed between the inner tube (2) and the outer tube (3) and a sliding bush (28) radially surrounding the inner tube (2) is provided and the telescopic suspension fork leg (1, 43) has a sealing device (24) radially surrounding the inner tube (2), which sealing device (24) has at least one sealing means (25) supported on an outer circumferential surface (27) of the inner tube (2), and a receiving chamber (37) for receiving damping fluid is provided between the sealing device (24) and the slide bush (28), wherein the telescopic suspension fork leg (1, 43) has at least one fluid passage (38) between the receiving chamber (37) and a receiving space (39) provided on the telescopic suspension fork leg.

The present invention refers to a telescopic suspension fork leg having an inner tube and an outer tube and a damping device and a spring device which is arranged within a first chamber formed in the inner tube or outer tube and is supported with respect to a second chamber formed by the damping device, and the telescopic suspension fork leg is designed to receive a damping fluid, the damping device having a piston supported on a piston rod and having an upper and a lower piston surface, and the piston being displaceable within a damping tube arranged substantially concentrically to the inner tube, and the damping tube being surrounded by an annular chamber arranged substantially concentrically to the damping tube, and a gap space being formed between the inner tube and the outer tube, and a sliding bush radially surrounding the inner tube being provided, and the telescopic suspension fork leg having a sealing device radially surrounding the inner tube, which has at least one sealing means supported on an outer circumferential surface of the inner tube and a receiving chamber for receiving damping fluid is provided between the sealing means and the slide bush, according to the generic term of claim 1.

The telescopic suspension fork leg according to the invention can be used, for example, to form a telescopic suspension fork or in short telescopic fork used on a motorcycle. The motorcycle can be an all-terrain sports motorcycle or a motorcycle for use on paved roads or a racing motorcycle or the like, as well as a more than single-track vehicle equipped with a telescopic suspension fork, for example an all-terrain vehicle ATV or quad or a bicycle or the like.

Such a telescopic fork fulfils the function of guiding a front wheel or wheels of the vehicle in question, provides suspension and damping when the vehicle moves over bumps in the road, thus ensuring that the spring movement quickly subsides and also provides support relative to the vehicle frame for a braking torque built up as a reaction torque when the front wheel or wheels are braked.

With such a telescopic suspension fork leg, there is regularly a great deal of attention paid to the sealing between the inner tube and outer tube or the dip tube and stand tube of the telescopic suspension fork leg, since on the one hand the leakage of damping fluid from the interior of the telescopic suspension fork leg must be prevented and on the other hand the ingress of dust and dirt into the interior must also be prevented.

For the latter purpose, a sealing device is provided between the outer tube and the inner tube to prevent the ingress of dust and dirt, which may be a dirt wiper, provided either as a separate component or formed integrally with the sealing device.

On the outer circumference of the inner tube there is a fluid film formed by the damping fluid in the form of the fork oil provided in the telescopic suspension fork leg, since the inner tube or dip tube dips into the outer tube or stand tube during the dynamic spring movement and fork oil is located in the outer tube or stand tube as the damping fluid, so that the outer circumferential surface of the inner tube or dip tube is wetted with fork oil. The fork oil must be prevented from escaping from the interior of the telescopic suspension fork leg and for this purpose a sealant provided on the sealing device in the form of, for example, a sealing lip is applied to the inner tube. The sealing lip has the task of retaining the fluid film by means of contact with the outer circumferential surface of the inner tube. This is to be understood both in terms of static tightness and dynamic tightness during dynamic operation of the telescopic suspension fork leg.

For this purpose, the sealing lip is in contact with the outer circumferential surface of the inner tube with a predetermined preload and wipes off a large part of the fork oil during a rebound movement, but a fluid film always remains on the outer circumferential surface of the inner tube. The sealing lip is statically preloaded by a spiral tension spring surrounding it and acting against the outer circumferential surface of the inner tube, and part of the preload is contributed by the elastic deformation of the sealing lip through its contact with the outer circumferential surface of the inner tube.

Although the static sealing behavior of the sealing lip can be influenced by increasing the preload force of the coil spring, an increase in the preload also causes the friction occurring between the sealing lip and the outer circumferential surface of the moving inner tube or dip tube to increase, which on the one hand worsens the wear behavior of the sealing lip and on the other hand also worsens the response behavior of the telescopic suspension fork leg, since the increased preload increases the breakaway torque. There is therefore a conflict of objectives between the sealing behavior of the telescopic suspension fork leg and the response behavior of the telescopic suspension fork leg in response to unevenness of the road surface on which the vehicle equipped with the telescopic suspension fork leg is moving.

On the basis of DE 10 2011 000 279 A1 a telescopic suspension fork leg and a telescopic suspension fork equipped with it has already been known, which has already proven its worth in practical use, but still offers room for improvement in order to ensure a constant response behaviour on uneven road surfaces even during longer dynamic use.

The Object of the present invention is therefore to create a telescopic suspension fork leg which addresses this problem and to provide a telescopic suspension fork leg which reliably maintains its response behaviour on uneven road surfaces even during dynamic operation of the telescopic suspension fork leg and also ensures that the sealing behaviour of the telescopic suspension fork leg can be improved and the response behaviour is improved.

In addition, a telescopic suspension fork with the telescopic suspension strut to be created should also be provided, and a method of manufacturing such a telescopic suspension strut should also be provided.

The invention exhibits the features indicated in claim 1 for solving this problem with respect to the telescopic suspension fork leg. Advantageous configurations of these features are described in the further claims.

In addition, the invention has the features indicated in claim 16 with respect to the telescopic suspension fork, and a method for manufacturing a telescopic suspension fork leg is indicated in claim 18.

The invention provides a telescopic suspension strut or fork leg having an inner tube and an outer tube and a damping device and a spring device disposed within a first chamber formed in the inner tube or outer tube and supported against a second chamber formed by the damping device, the telescopic suspension strut being adapted to receive a damping fluid, the damping device having a piston supported on a piston rod and having an upper and a lower piston surface, and the piston being displaceable within a damping tube arranged substantially concentrically to the inner tube, and the damping tube being surrounded by an annular chamber arranged substantially concentrically to the damping tube, and a gap space being formed between the inner tube and the outer tube, and a sliding bush radially surrounding the inner tube being provided, and the telescopic suspension fork leg having a sealing device radially surrounding the inner tube, which has at least one sealing means supported on an outer circumferential surface of the inner tube and a receiving chamber for receiving damping fluid is provided between the sealing means and the slide bush, the telescopic suspension fork leg having at least one fluid passage between the receiving chamber and a receiving space provided on the telescopic suspension fork leg.

The inventors of the telescopic suspension fork leg according to the invention have recognized that the preload with which the sealing lip is applied to the outer circumferential surface of the inner tube does not only depend on the preload which is caused by the elastic deformation of the sealing device on the inner tube and the tensite stress of the spiral tension spring acting on the sealing device, but also by the pressure conditions that arise during operation of the telescopic suspension fork leg in the area of the boom body forming the sealing lip, with which the sealing lip is moulded onto the radial shaft seal provided as a sealing device.

During a rebound movement of the telescopic suspension fork leg, damping fluid is pushed via the annular gap space formed between the slide bushing and the inner tube into the area behind the boom body, and a pressure increase occurs in this area, which acts as a receiving chamber for the damping fluid. As a result, the dynamic movement of the telescopic suspension fork leg significantly increases the preload with which the sealing lip contacts the outer circumferential surface of the inner tube. The pressure in the sealing gap between the sealing lip and the outer circumferential surface or surface of the inner tube is therefore increased.

During a deflection movement of the telescopic suspension fork leg, the damping fluid adhering to the inner tube carries damping fluid along with it via the cohesion effect occurring in the damping fluid, and is transported out of the receiving chamber, so that a pressure level can be set in the receiving chamber, which is lower than the ambient pressure, since the pressure in the sealing gap drops significantly, so that air from the environment can flow into the telescopic suspension fork leg, which is to be regarded as a closed system, i.e. can enter the interior of the telescopic suspension fork leg.

Due to the fact that the fork oil adheres to the outer circumferential surface of the tube, the moving tube of the telescopic suspension fork leg causes the pressure and thus the pressure conditions in the area of the sealing gap to change significantly depending on the direction of movement of the moving tube compared to the pressure between the sealing lip and the outer circumferential surface of the tube due to the installation. This leads to the unsatisfactory condition that due to the change of the internal pressure in the telescopic suspension fork leg occurring during dynamic operation, the response of the telescopic suspension fork leg to road unevenness also changes.

This means in other words that the spring and damping behaviour of the telescopic suspension fork leg changes during operation and the internal pressure in the telescopic suspension fork leg system, which increases due to the dynamic operation of the telescopic suspension fork leg, must be normalized. For this purpose, a release valve is provided in each case for a known telescopic suspension fork leg, with which the increased internal pressure can be released by opening the release valve.

By releasing the increased internal pressure from the interior of the telescopic suspension fork leg, the resulting problem of the changing response of the telescopic suspension fork leg can be mitigated, but there is no change in the cause of the problem.

The telescopic suspension strut, which is in accordance with the invention, provides a remedy here by providing a fluid passage between the receiving chamber and a receiving space provided on the telescopic suspension strut.

The telescopic suspension strut thus equipped according to the invention creates a fluidic connection between the receiving chamber and a receiving space provided on the telescopic suspension strut through the fluid passage and thus enables damping fluid, which is carried into the receiving chamber or dragged or transported with it, to flow out of the receiving chamber via the dynamic movement of the telescopic suspension strut, in the direction towards or into the receiving space on the telescopic suspension fork leg and thus a considerable increase in pressure in the receiving chamber caused by the drag pressure cannot occur and thus the pressure or surface pressure in the sealing gap between the sealant of the sealing device and the outer circumferential surface of the moving tube of the telescopic suspension fork leg is no longer subject to the large fluctuations as is the case with the known telescopic suspension fork leg and this has been described in detail above.

Thus, when the moving tube of the telescopic suspension fork leg of the invention, which may be the dip tube or inner tube, is moved relative to the stand tube fixed to the vehicle during operation of the vehicle equipped therewith, the damping fluid in the form of the fork oil and the contact surface of the fork oil on the moving tube is passed over the contact surface of the tube, i.e. the outer circumferential surface or contact surface between the sealing lip and the moving tube, the prevailing adhesive force is carried along by fork oil via the gap between the slide bushing and the outer circumferential surface and transported into the receiving chamber, i.e. for example a space in the area of or behind the sealing lip.

However, the fork oil there is not subjected to increasing dynamic pressure via the further movement of the immersion tube and the associated further transport of fork oil into the receiving chamber, as is the case with the well-known telescopic suspension fork leg, which would lead to a significant increase in pressure and between the sealing lip and the outer circumferential surface, but the fork oil carried away can flow off via the fluid passage between the receiving chamber and a receiving space provided on the telescopic suspension fork leg, so that an increasing dynamic pressure is no longer formed and thus the working pressure in the receiving chamber and thus the pressure or surface pressure between the sealing lip of the sealing device of the outer circumferential surface of the moving tube remains constant or almost constant over the entire or largely entire relative travel or deflection travel of the immersion tube to the standpipe.

This in turn leads to the fact that the sealing device or the sealant or the sealing lip can be arranged or installed relative to the outer circumferential surface of the moving tube with such a pretension or compression or surface pressure that on the one hand a sufficient tightness against the leakage of fork oil in the static state and also in the dynamic state is achieved and on the other hand the formation of a negative pressure in the receiving chamber can be prevented, so that the problem of air flowing from the environment into the interior of the telescopic fork leg can also be eliminated and this in turn leads to this, in that the response behaviour of the telescopic playback leg and the telescopic suspension fork formed therewith remains the same even in dynamic operation, i.e. the feedback felt by the driver or user of the vehicle equipped with the telescopic suspension legs or the telescopic suspension fork of the invention does not change substantially even after a longer period of operation, since the internal pressure in the system or the internal pressure in the interior of the telescopic suspension leg of the invention does not change due to the absence of an air flow into the interior.

By minimizing the preload with which the sealing lip is in contact with the outer circumferential surface of the moving tube, the preload can be minimized in such a way that the telescopic suspension fork leg is fluid-tight in static and dynamic operation against the escape of damping fluid on the one hand, and on the other hand the static preload does not have to be increased to such an extent that the telescopic suspension fork leg remains tight even if a negative pressure occurs in the receiving chamber, since such a negative pressure situation is no longer given, since damping fluid can also flow back from the receiving chamber into the receiving chamber via the at least one fluid passage, the sealing lip now rests on the outer circumference with a largely constant preload, whereby the breakaway torque or breakaway force of the telescopic suspension strut or telescopic suspension fork of the invention is reduced compared to known telescopic suspension struts or telescopic suspension forks.

Since a pressure equalization takes place via the at least one fluid passage between the receiving chamber and the receiving space provided on the telescopic suspension fork leg, it is now also possible to adjust the configuration of the sealing lip and the internal pressure prevailing in the interior of the telescopic suspension fork leg in such a way that during the dynamic movement of the telescopic suspension fork leg according to the invention, an oil film is formed on the outer circumferential surface with such a thickness that a dirt scraper provided on the telescopic suspension fork leg no longer needs to be dimensioned in such a way, that it can retain a maximum thick oil film, but can be dimensioned in such a way that it can retain the now prevailing film thickness of the oil film, which in turn reduces the breakaway torque of the telescopic suspension fork or telescopic suspension strut according to the invention, and in addition, the ingress of dirt into the interior of the telescopic suspension strut can be further reduced, since the dirt wiper always contacts the outer circumference of the telescopic suspension strut with the predetermined, appropriate pretension.

In addition, the telescopic suspension strut according to the invention has the advantage that the frictional torque values measured by means of a test bench setup are much more constant over a long period of dynamic use than with the well-known telescopic suspension strut, since the continuous circulation of damping fluid from the contact area of the sealing lip on the outer circumferential surface of the moving tube and the gap between the slide bushing and the moving tube flushes out any unavoidable dirt particles present in the system from the contact area and thus, on the one hand, the frictional behaviour remains largely constant even during long operation and, on the other hand, the circulation of the damping fluid prevents premature ageing of damping fluid remaining in the contact area for a long time. Such premature aging would in fact also lead to a significant increase in the detectable friction torque values within a short time. Here, too, the invention creates significant advantages in reducing the increase in the friction torque values and the further advantage that the damping fluid used ages uniformly and thus the intervals between changes of the damping fluid can be extended.

It is intended, according to a further development of the invention, that the receiving space is formed by the gap space or one of the first or second chambers. In other words, it means that the fluid passage extends or runs from the receiving chamber to the gap space formed between the inner tube and the outer tube, or may also extend to the first chamber or second chamber of the telescopic suspension fork leg, or is in fluid communication with one of the aforementioned spaces or areas.

This ensures that the damping fluid which accumulates in the receiving chamber in the form of, for example, the above-mentioned fork oil can flow out via the at least one fluid passage into the gap space or the first chamber or the second chamber and thus the formation of a significantly changing and/or increasing dynamic pressure in the receiving chamber no longer occurs and therefore the working pressure in the receiving chamber during the dynamic operation of the telescopic suspension fork leg of the invention largely corresponds to the pressure which is established in the interior of the telescopic suspension fork leg. This pressure occurring in the interior space is decisively determined by the compression and rebound movement of the telescopic suspension fork leg, since the compression movement causes the internal pressure in the telescopic suspension fork leg to increase, since the volume of the telescopic suspension fork leg available for the volume of air enclosed in the interior space decreases during the compression movement, and this is accompanied by an increase in pressure, while the internal pressure decreases during the rebound movement, since the volume available increases and thus the internal pressure decreases.

It is also provided, after further development of the invention, that the at least one fluid passage is formed on the slide bushing and/or the outer pipe.

The design at or in the area of the slide bushing ensures that an already existing installation space or an already existing component of the telescopic suspension fork leg according to the invention is used to integrate the at least one fluid passage and no additional component has to be installed in the telescopic suspension fork leg to form the at least one fluid passage. For this purpose, the at least one fluid passage can be arranged, for example, on the outer circumferential surface of the slide bushing so that fork oil accumulating in the receiving chamber can drain off via this fluid passage into the gap space formed between the inner tube and outer tube.

It is also possible to provide the at least one fluid passage on the outer tube of the telescopic suspension fork leg of the invention, on the inner circumferential surface of the outer tube, so that the fork oil can flow from the receiving chamber, for example, back into the gap formed between the inner and outer tubes.

It is also provided, according to a further development of the invention, that a hollow cylindrical body is provided radially between the slide bushing and the outer pipe and that the body is provided with the at least one fluid passage. This hollow cylindrical body can therefore be provided concentrically to the slide bushing or at least in sections concentrically to the slide bushing and have a fluid passage which connects the receiving chamber with the receiving space. This configuration offers the advantage that further functional surfaces of the telescopic suspension fork leg, which is the subject of the invention, can also be integrated into this hollow cylindrical body.

It is also provided, according to a further development of the invention, that the at least one fluid passage extends into an area relatively supporting the sealant against the outer circumferential surface of the inner pipe. In this way, the fluid passage can also already form part of the receiving chamber. The sealant, for example the sealing lip already mentioned above, can be formed, for example moulded, on an extension arm of a shaft sealing ring of hollow cylindrical cross-section, so that the area radially outside the extension arm and inside the inner circumferential surface of the outer tube forms the receiving chamber.

It is also possible that the shaft sealing ring has a shaped surface radially outside the extension arm, which is formed by a body moulded onto the shaft sealing ring and an extension of hollow cylindrical or pot-shaped cross-section, and this serves to centre and abut the shaft sealing ring with its outer circumferential surface against the inner circumferential surface of the outer tube, so that the receiving chamber is formed between the extension arm and this body.

It is also provided, according to a further development of the invention, that the at least one fluid passage extends into an area relatively supporting the sealant against the outer circumferential surface of the inner pipe. Thus the at least one fluid passage creates, as it were, an axial extension of the receiving chamber and ensures that the fork oil accumulating in the receiving chamber is provided with a flow path in the direction of the receiving space, i.e. for example the gap between the inner tube and the outer tube, which has a low flow resistance and thus the damping fluid dragged by the dynamic movement of the telescopic suspension fork leg according to the invention can flow out of the receiving chamber without great flow resistance.

It is also provided according to a further development of the invention that the at least one fluid passage is formed by a groove connecting the receiving chamber and the receiving space fluidically or for fluid communication.

This groove can have various cross-sectional shapes and can be formed on the outer circumferential surface of the slide bushing, for example, during production. The groove can also be formed on the inner circumferential surface of the outer pipe, either by machining or non-cutting.

It is also provided, according to a further development of the invention, that the at least one fluid passage is located on an inner circumferential surface of the outer tube and extends between the fission chamber and the receiving chamber. The fluid passage can be formed, for example, by means of the aforementioned groove which is formed on the inner circumferential surface of the outer tube and therefore the groove acts as a fluid channel between the gap space formed between the inner tube and the outer tube and the receiving chamber. Through the fluid passage, fork oil or damping fluid can flow in both directions, i.e. in the direction in which it enters the receiving chamber and also in the direction out of the receiving chamber.

It is also provided according to a further development of the invention that the at least one fluid passage is formed on an outer circumferential surface of the slide bushing and extends between the gap space and the receiving chamber. The fluid passage can, for example, be formed or made on the outer circumferential surface of the slide bushing during its manufacture, and it is also possible that two or more than two fluid passages are equally distributed on the outer circumference of the slide bushing so that flow paths are available for the fork oil accumulating in the receiving chamber, so that the fork oil can flow out of the receiving chamber and can also flow into the receiving chamber.

It is also generally intended, following further development of the invention, that the at least one fluid passage is in the form of a groove extending between the receiving chamber and the receiving space, which has a configuration extending at least substantially parallel or at an angle to a portion of a longitudinal central axis of the telescopic suspension fork leg and is formed on an inner peripheral surface of the outer tube and/or an outer peripheral surface of the slide bushing and/or is formed on a body of hollow cylindrical shape which is provided radially between the slide bushing and the outer tube or in the longitudinal extent of the slide bushing.

It is also provided, after a further development of the invention, that the at least one fluid passage is in the form of a groove extending between the receiving chamber and the receiving space, which groove is formed on an inner peripheral surface of the outer tube and/or an outer peripheral surface of the slide bushing in the form of a helix or spirally formed channel extending helically around a portion of a longitudinal central axis of the telescopic suspension fork leg.

In other words, it means that the groove is formed in the shape of a helix or spiral formed on an outer circumferential surface of the slide bushing or formed on an inner circumferential surface of the outer tube so that the fluid passage or fluid channel extends helically or spirally around a portion of a longitudinal central axis of the telescopic suspension fork leg.

The invention also provides according to a further development, that the at least one fluid passage has a cross-sectional area which corresponds at least to the area of an annular gap area formed between the inner pipe and the slide bushing.

This ensures that the damping fluid has a return flow possibility with low flow resistance. The cross-section of the at least one fluid passage or fluid channel can take different shapes and it has been shown that the fluid channel should have a cross-sectional area at least equal to the area of the annular gap surface formed between the outer circumference of the inner tube and the slide bushing.

It is intended, following further development of the invention, that this cross-sectional area should correspond to a value in the range of from one to five times, preferably from one to three times, preferably about three times, the area of the said annular gap. The cross-sectional area can be distributed over more than one fluid channel or fluid passage, for example two or three fluid channels or fluid passages can be provided, the total area of which corresponds to approximately three times the value of the area of the annular gap area between the inner tube and the slide bushing.

It is provided, according to a further development of the invention, as well as that the at least one fluid passage in the form of fluid passages is arranged in the circumferential direction of the outer circumference of the slide bushing or the inner circumference of the outer tube at the same distance from each other, the fluid passages thus being equally distributed with respect to the angle in the circumferential direction.

It is also intended, according to a further development of the invention, that the at least one fluid passage has a shape similar to a segment of a circle in a cross-sectional view. Such a shape is created when a circle with a surface arranged at right angles to the circle intersects the circle. In a cross-sectional view, therefore, the shape is similar to a segment of a circle. More than one such circle-segment-shaped fluid passages can then be arranged, for example, on the inner circumferential surface of the outer pipe so that there is a portion extending in the longitudinal direction of the outer pipe on the inner circumferential surface of the outer pipe which is coaxial with the slide bushing so that fluid passages are provided radially outside the slide bushing.

The invention also provides a telescopic suspension fork with two telescopic suspension fork legs as explained above, the telescopic suspension fork legs being arranged in such a way that the damping device is located respectively below or above the first chamber receiving the spring device.

The invention thus also creates a telescopic suspension fork, which has two telescopic suspension legs, in which the spring device acting as the main spring can be arranged at the top or bottom when mounted on the vehicle, for example on a motorcycle, viewed in the vertical axis direction of the vehicle. The spring device can thus be arranged closer to the road surface of a vehicle travelling on it or also at a distance therefrom in the region of triple clamps which are provided on the telescopic suspension fork provided for in the invention or on the vehicle equipped with it.

The invention also creates a motorcycle with a front wheel and a rear wheel as well as a driver's saddle and a drive motor, the motorcycle having a telescopic suspension fork as described above.

For example, the motorcycle can be a racing motorcycle, which is used for road racing. With such a racing motorcycle the inventive telescopic suspension fork with the inventive equipped telescopic suspension fork legs ensures that when driving over bumps on the racetrack, which appear in the form of washboard-like elevations and depressions, the response of the telescopic suspension fork perceived by the rider of the motorcycle does not change throughout the passing of the multitude of bumps and depressions, so that the response of the last pair of bumps and depressions still corresponds to the response of the telescopic suspension fork at the first pair of bumps and depressions. This constant behaviour also ensures that the wheel guiding force does not change when driving over uneven road surfaces, thus allowing higher cornering speeds in areas with uneven road surfaces.

This is because the radial pretension of the shaft seals on the two telescopic suspension fork legs can also be optimized or reduced, i.e. they no longer have to be adapted to a worst case scenario that takes into account overpressure situations and underpressure situations in the area of the sealing lips, the overall pretension of the shaft seals can be reduced and thus the response of the telescopic suspension fork can be improved, since a lower pretension of the shaft seals also leads to a reduction of the breakaway torque of the telescopic suspension fork according to the invention compared to known telescopic suspension forks and the telescopic suspension fork according to the invention therefore responds more sensitively to uneven ground.

Finally, the invention also provides a method of manufacturing a telescopic suspension fork leg having the features as described above, wherein the at least one fluid passage is formed on an inner circumferential surface along a longitudinal direction of the outer tube, wherein, according to the method according to the invention, firstly a tubular body provided for forming the outer tube is provided and then a mandrel tool supporting the tubular body on the inside and having at least one projecting outer contour is introduced into the tubular body up to a region close to the at least one fluid passage to be formed and then the tubular body and the mandrel tool are moved relative to one another in such a way, in that the protruding outer contour forms the at least one fluid passage on an inner circumferential surface of the tube body by means of a non-cutting shaping process.

The standpipe or outer pipe has the largest outer diameter in the area of the sealing device and with the above mentioned mandrel tool, not only the diameter on the pipe material can be expanded in this way to form the outer pipe and accommodate the sealing device, but the mandrel tool can also be used to introduce the at least one fluid passage in the axial longitudinal direction of the outer pipe simultaneously in one operation together with the expansion of the diameter of the pipe material, for example at the point where the slide bushing for guiding the inner pipe relative to the outer pipe is inserted.

The at least one fluid channel or fluid passage is then located radially outside the slide bushing, so that the at least one fluid channel or fluid passage is located between the slide bushing and the inner circumference of the outer pipe, as viewed from the outer pipe.

The invention is explained in more detail below on the basis of the drawing. This drawing shows in:

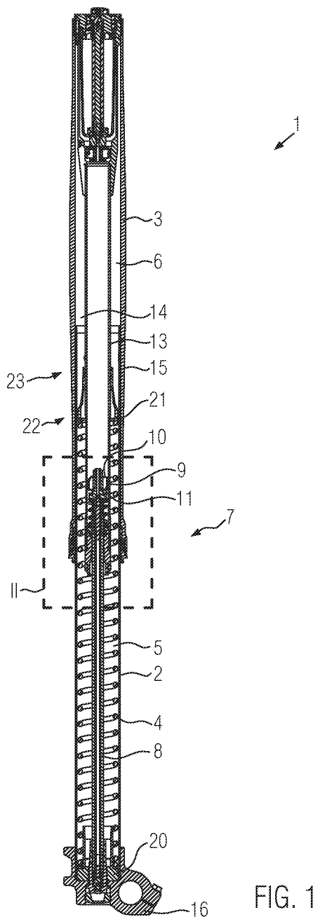

FIG. 1 a longitudinal sectional view of a telescopic suspension fork leg according to a first embodiment in accordance with the present invention;

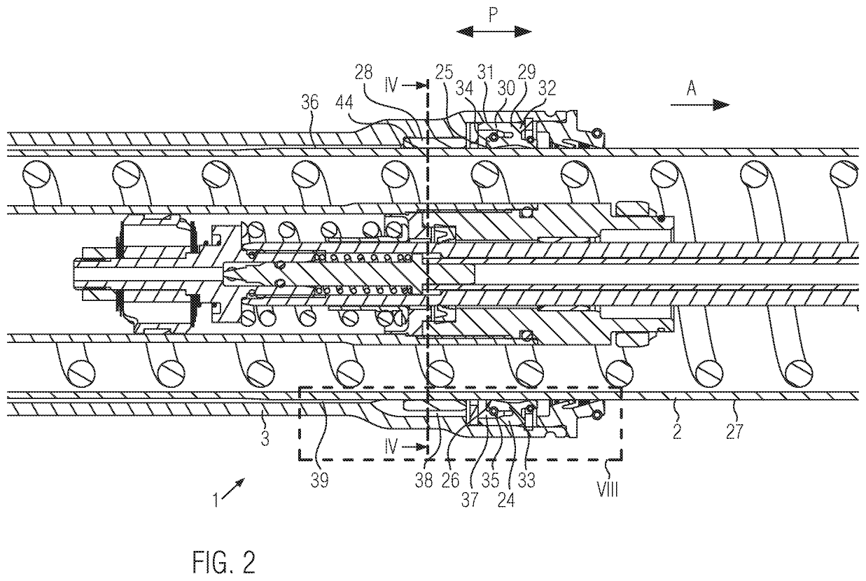

FIG. 2 an enlarged representation of a section II according to FIG. 1;

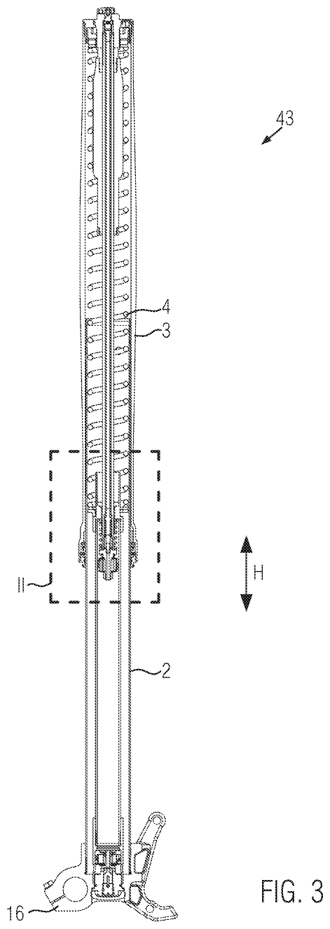

FIG. 3 a representation of a telescopic suspension fork leg according to a second embodiment in accordance with the present invention;

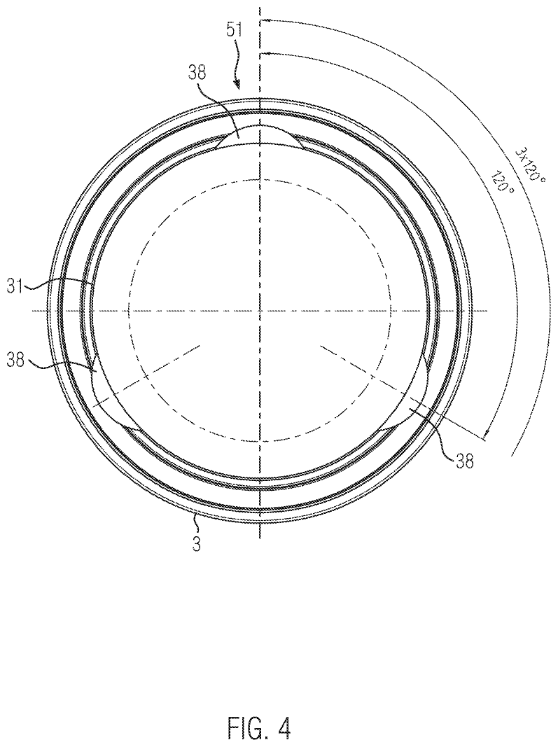

FIG. 4 a sectional view of an outer tube of the telescopic suspension fork leg according to the first or second embodiment;

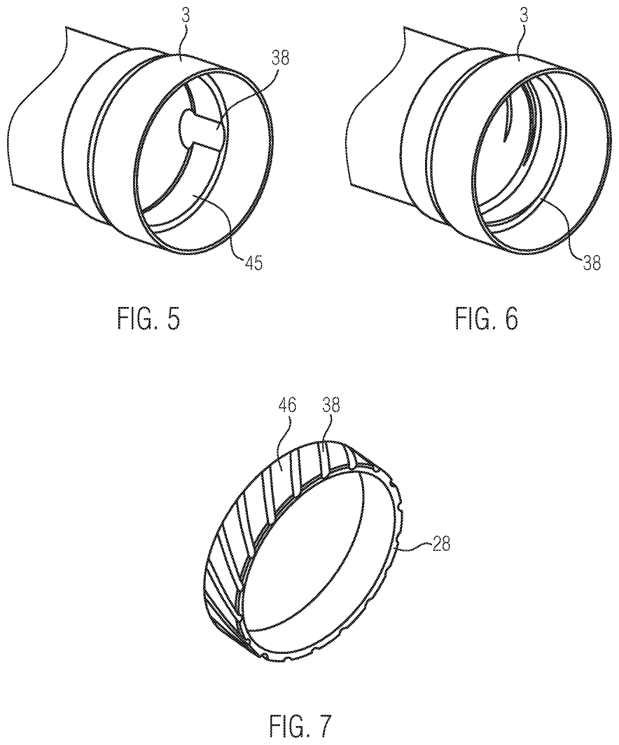

FIG. 5 a perspective view of a section of the outer pipe according to FIG. 4 of the drawing to explain the position of the fluid passage;

FIG. 6 a perspective view of a section of an outer pipe according to a modified embodiment of the fluid passage;

FIG. 7 a perspective view of a slide bushing with a large number of fluid passages arranged on it;

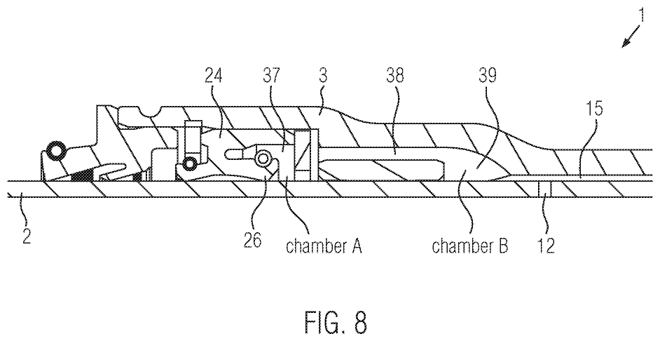

FIG. 8 a section of a telescopic suspension fork leg according to the present invention to explain pressure measuring points;

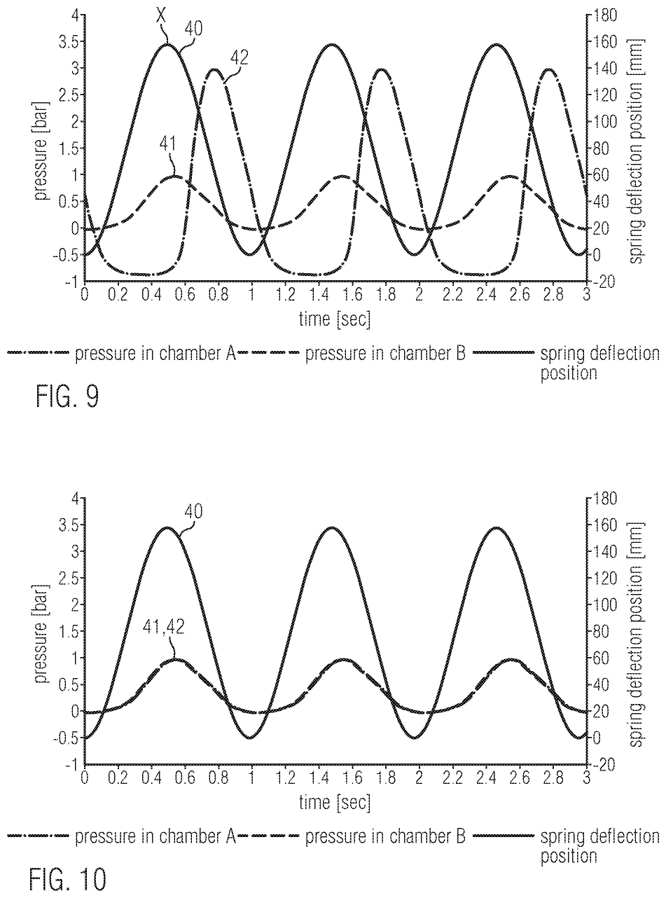

FIG. 9 a diagram of the pressure curve at the pressure measuring points, taken from a known telescopic suspension fork leg;

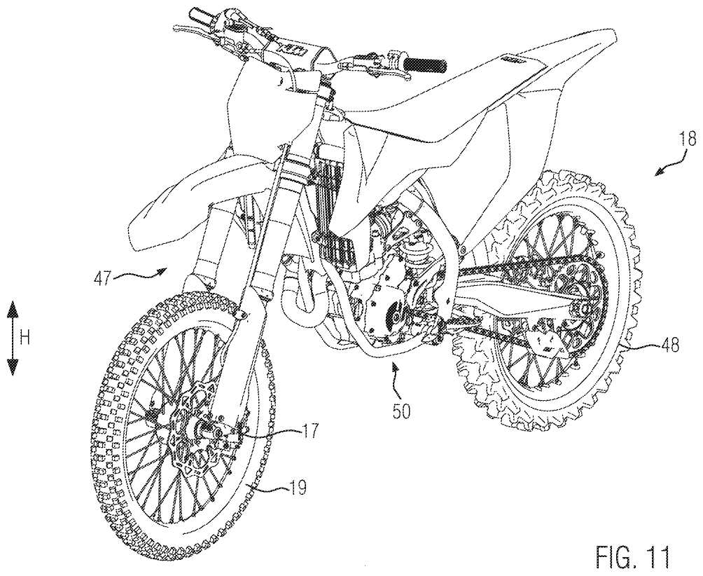

FIG. 10 a diagram of the pressure curve at the pressure measuring points, recorded on the telescopic suspension fork leg as invented;

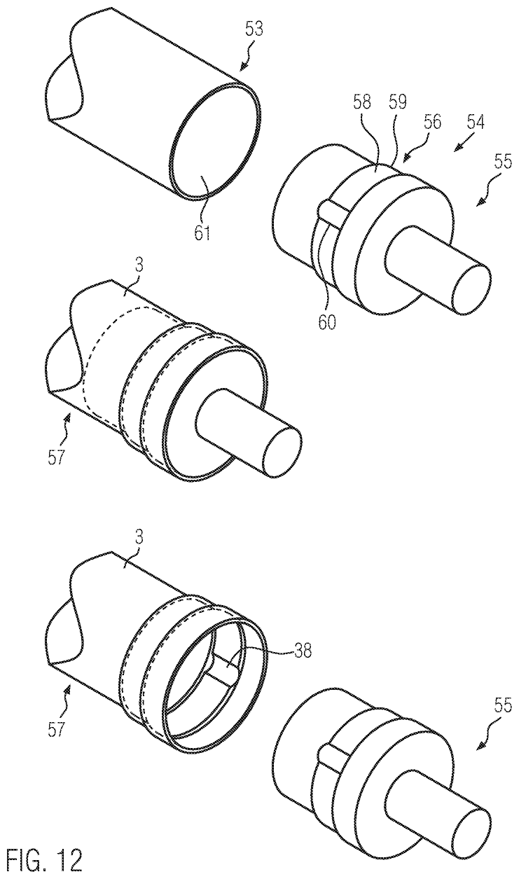

FIG. 11 a perspective view of a motorcycle with one telescopic suspension fork according to the invention with two telescopic suspension fork legs; and

FIG. 12 perspective schematic representations of a tubular body for forming the outer tube and of a tool for forming the tubular body without cutting and chipless insertion of fluid passages.

FIG. 1 of the drawing shows a telescopic suspension fork leg 1 with an inner tube 2 and an outer tube 3 and a spring device 4, which is arranged in a first chamber 5 in the embodiment of the telescopic suspension fork leg 1 shown in FIG. 1 of the drawing. The spring device 4 is supported against a damping device 7 formed by a second chamber 6, and the telescopic suspension strut 1 is designed to receive a damping fluid in the form of a fork oil which is not shown in detail.

The damping device 7 generally comprises a piston rod 8, on which a piston or working piston 9 is supported, which has an upper or first piston surface 10 and a lower or second piston surface 11, and the piston 9 is displaceable within a damping tube 13 which is largely concentric with the inner tube 2.

The damping tube 13 is surrounded by an annular chamber 14 which is largely concentric with the damping tube 13 and forms the area between the outer circumferential surface of the damping tube 13 and the inner circumferential surface of the outer tube 3.

As can be seen in more detail from FIG. 2 of the drawing, a gap space 15 is provided between the inner tube 2 and the outer tube 3, in which fork oil is located during normal operation of the telescopic suspension fork leg 1, which acts as a hydraulic damping fluid.

At the lower end of the telescopic suspension fork leg 1 there is a clamping first 16 formed on which the front wheel 19 of the motorcycle 18 can be rotatably fixed via the removable axle 17 of the motorcycle 18 shown in FIG. 11 of the drawing.

The spring device 4 is supported in the area of the clamping first 16 on a cover 20 and in the area of the opposite end on a cover 21 of a sliding sleeve 22, which can be displaced along the damping tube 13 and serves to fix and axially guide the main spring 4.

Since the interior 23 of the telescopic fork leg 1 is filled with fork oil and this must be prevented from leaking out of the telescopic fork leg 1, the fork oil must be removed as shown in FIG. 2 of the drawing, a sealing device 24 is provided radially surrounding the inner tube 2, which comprises a sealing means 25 in the form of a sealing lip 26 which bears against the outer peripheral surface 27 of the inner tube 2 and is intended to retain the fork oil at the outlet during the relative movement of the inner tube 2 relative to the outer tube 3 in the direction of the double arrow P shown in FIG. 2 of the drawing.

For axial guidance and to support the inner pipe 2 on the outer pipe 3, a slide bushing 28 is provided radially to the outer pipe 2 and concentrically thereto, which can be provided on the radial inner circumferential surface with a coating in the form of, for example, a polytetrafluoroethylene coating, which on the one hand reduces the friction during the relative movement of the inner pipe 2 on the slide bushing 28 and on the other hand also has a wear-reducing effect.

The sealing device 24, which in the embodiment shown is in the form of a rotary shaft seal 29, has a supporting body 30 in the form of a cylindrical body, which is provided for support on the inner circumferential surface 31 of the outer tube 3 and on the end face of which an elongated extension arm 33 is formed, on the end face of which, distal from the end face 32, the sealing lip 26 is formed. The sealing lip 26 is pretensioned against the outer circumferential surface 36 of the inner pipe 2 by a spiral tension spring 35 acting on the outside of the end area 34.

This configuration causes the damping fluid adhering to the outer circumferential surface 36 of the inner tube 2 due to the adhesive effect to be retained by the sealing lip 26 during the rebound movement of the telescopic suspension fork leg 1 in the direction of arrow A as shown in FIG. 2, and the fork oil thus scraped off collects in a receiving chamber 37 provided between the sealing device 24 and the slide bushing 28 or more generally in the area of the sealing device 24.

As a result of the further rebound movement of the telescopic suspension fork leg 1 with the movement of the inner tube 2 in the direction of arrow A according to FIG. 2, more oil accumulates in the receiving chamber 37 and this leads to a build-up of back pressure in the receiving chamber 37.

In the case of a known telescopic suspension fork leg, this accumulation of fork oil in the receiving chamber leads to pressure conditions which can be seen in more detail in FIG. 9, as can be determined using a measuring set-up explained below in FIG. 8 of the drawing.

The measuring set-up according to FIG. 8 shows a section according to area VIII of FIG. 2 of the drawing. The pressure diagram according to FIG. 10 of the drawing was also determined with the measuring set-up shown in FIG. 8, which shows the pressure conditions with a telescopic suspension strut 1 according to the invention, while FIG. 9, used for comparison, shows the pressure conditions with the known telescopic suspension strut.

FIG. 8 shows the inner tube 2 and the outer tube 3 as well as the sealing device 24 with the receiving chamber 37 and the gap space 15 between the inner tube 2 and the outer tube 3. FIG. 8 also shows a bore 12 provided on the inner tube 2, through which fork oil, which flows via the bypass channel 38 into the gap space 15, can easily flow into the interior of the telescopic suspension fork leg 1. It is also possible to provide several holes 12 on the circumference of the inner tube 2, so that the flow resistance for the fork oil flowing into the gap space 15 is further reduced.

The one in FIG. 8 is now characterized by the fact that the telescopic suspension strut 1 has a fluid passage 38 or fluid channel or bypass channel between the receiving chamber 37 and the gap space 15, which ensures that the telescopic suspension strut 1 is not damaged, in that the fork oil accumulating in the receiving chamber 37 can flow via the fluid passage 38 into the receiving chamber 39, which is designed as a gap chamber 15 in the illustrated design, and the formation of a dynamic pressure in the receiving chamber 37, which still occurs in the configuration of the known telescopic suspension fork leg, can thus be avoided.

FIG. 9 of the drawing shows the pressure conditions in the receiving chamber and the gap space with a known telescopic suspension strut, which differs from the configuration according to FIG. 8 of the drawing in that the known telescopic suspension strut does not have the fluid passage or fluid channel or bypass channel 38.

To determine the pressure conditions shown in the diagrams in FIG. 9 and FIG. 10 of the drawing, the pressure in chamber A and chamber B is measured, which is the result of a dynamic spring movement of the telescopic suspension fork leg.

FIG. 9 shows the pressure conditions which result from the measuring set-up shown on the known telescopic suspension fork leg, while FIG. 10 shows the pressure conditions which result from the measuring set-up shown on the telescopic suspension fork leg 1, which is in accordance with the invention.

To determine the pressure conditions, both the known and the invented telescopic suspension fork leg were subjected to a test drive, which is characterized by a sinusoidal spring movement, which is shown in the diagram according to FIG. 9 and in the diagram according to FIG. 10, each with a sinusoidal oscillation 40, which led to the pressure conditions also shown.

Curve 41 according to FIG. 9 shows the pressure build-up at the measuring point of chamber B according to FIG. 8, while curve 42 shows the pressure build-up at the measuring point of chamber A according to FIG. 8.

As can be seen from FIG. 9 of the drawing, the pressure build-up in chamber B follows the internal pressure in the gap 15 corresponding to the compression position or the interior of the telescopic suspension fork leg, since the air volume enclosed in the telescopic suspension fork leg is compressed by the compression movement and thus the internal pressure in the interior 23 of the telescopic suspension fork leg changes periodically with the periodically oscillating compression position.

Curve 42, which shows the pressure curve in the measuring point of chamber A according to FIG. 8, i.e. the internal pressure determined in chamber A, the internal pressure initially drops significantly with the increasing compression position of the known telescopic suspension fork leg, it even drops below the ambient pressure of the pressure curve shown in FIG. 9 and FIG. 10, which means that at the measuring point of chamber A a negative pressure is established, which leads to the fact that air from the environment can flow into the interior 23 of the known telescopic suspension fork leg, which is then enclosed in the interior and leads to the above described problem of inflating the known telescopic suspension fork leg.

After the maximum compression position marked with the turning point X is reached and the telescopic suspension fork leg is subjected to a rebound movement, fork oil is entrained into chamber A by the inner tube, which is wetted with fork oil on the outer circumference, and the problem of the formation of dynamic pressure described above occurs there, whereby the ram pressure is applied to the boom, with the result that the sealing lip of the known telescopic suspension fork leg is pressed with high pretension against the outer circumferential surface of the inner tube of the known telescopic suspension fork leg, thereby significantly increasing the friction at the point of contact between the sealing lip and the outer tube of the known telescopic suspension fork leg.

The pressure curve 42 shows that as the internal pressure 41 decreases, the pressure in chamber A increases abruptly and therefore the sealing device with the sealing lip resting on the outer circumference of the inner tube must be able to cope with a much larger pressure range than is given by the internal pressure prevailing in the telescopic suspension fork leg. Since even a negative pressure is created in chamber A during the compression movement of the known telescopic suspension fork leg, this leads to the sealing lip losing its contact with the outer circumference of the inner tube of the known telescopic suspension fork leg and thus to leaks. This can only be compensated for by the fact that the spiral tension spring applies a high preload to the sealing lip of the known telescopic suspension fork leg against the outer circumferential surface of the inner tube, which results in a high surface pressure in the area of the sealing lip and the outer tube, which in turn leads to a high frictional torque at the contact point and thus to poor response behavior of the known telescopic suspension fork leg.

Since the spring movement is constantly repeated during the driving operation of a vehicle equipped with the known telescopic suspension strut, the effect of inflating the interior of the known telescopic suspension strut causes the internal pressure to increase significantly and must be released by actuating a valve provided on the known telescopic suspension strut. The response of the known telescopic shock absorber is therefore not constant, but is subject to large fluctuations which can be detected by the driver of the vehicle equipped with it while driving.

If, for example, a vehicle equipped with the known telescopic suspension strut passes over a washboard-like road profile while driving, the large number of spring movements occurring in a short time leads to a drastic change in the response behaviour of the known telescopic suspension strut within a short time, which is perceived by the driver of the vehicle as a deterioration of the response behaviour, since this deterioration also occurs in particular at different time intervals, depending on how many spring movements the known telescopic suspension strut experiences while driving.

FIG. 10 of the drawing shows, in direct comparison to FIG. 9 of the drawing, the significant improvement achieved with the telescopic suspension strut 1, which is in accordance with the invention.

Curve 40 again shows the sinusoidal spring deflection position and the two curves 41 and 42 in FIG. 9, which still deviate considerably from each other in their course, coincide in FIG. 10. The pressure curve in chamber A of the telescopic suspension fork leg 1 now follows the pressure curve in chamber B of the telescopic suspension fork leg 1, since the rebound movement in the receiving chamber 37 (chamber A) allows fork oil entrained in the rebound movement to flow via the bypass channel 38 into the receiving chamber 15, which is formed, for example, by the gap 15 (chamber B) between the outer tube 3 and the inner tube 2.

The curves in FIG. 10 show that with a compression movement of the telescopic suspension fork leg 1, i.e. with increasing compression position, the pressure in chamber A (receiving chamber 37) increases in the same way, i.e. with corresponding speed and amplitude, as the pressure in chamber B (gap chamber 15) and with a rebound movement decreases again in the same way as the pressure in chamber B, i.e. the pressures in chamber A and chamber B largely correspond or are largely the same. Thus, it can also be easily determined whether a telescopic suspension fork leg to be examined corresponds to a known telescopic suspension fork leg or corresponds to the telescopic suspension fork leg according to the invention.

The fact that the telescopic shock absorber, as defined in the invention, no longer suffers from the formation of a vacuum in the receptacle chamber corresponding to chamber A also makes it possible to reduce the preload to be applied by the spiral tension spring 35 without adversely affecting the tightness, thus eliminating the phenomenon of inflation of the telescopic shock absorber described above, the telescopic suspension fork leg according to the invention and a telescopic suspension fork formed therewith are characterised by a constant response behaviour even in dynamic operation, also short spring movements of the telescopic suspension fork according to the invention with the telescopic suspension fork legs according to the invention caused by a road surface formed like a washboard ensure that the response behaviour of the telescopic suspension fork when driving over the last excitation does not differ from the response behaviour when driving over the first excitation.

A user or driver of a vehicle which has a telescopic suspension fork with the telescopic suspension strut according to the invention will not experience any change in the response behaviour of the telescopic suspension fork even during a racing event with the vehicle and therefore does not have to adjust to the fact that the telescopic suspension fork shows a different response behaviour at the beginning of a race, for example, than is the case in the final phase of the race. This also makes it possible, for example, for the speed of the vehicle to increase when driving through curves with uneven road surfaces, as the telescopic suspension fork always shows a constant response behaviour, i.e. spring and damping behaviour, and does not show a hardening response behaviour even with increasing driving time.

FIG. 3 of the drawing shows a longitudinal sectional view of a telescopic suspension fork leg 43 according to a modified version according to the present invention. As can be seen without further ado, the telescopic suspension strut shown in FIG. 3 differs from the telescopic suspension strut 1 according to FIG. 1 in that the telescopic suspension strut 43 has a spring device 4 which is arranged at the opposite end region of the telescopic suspension strut 43 instead of in the region adjacent to the clamping first 16, i.e. in the vertical axis direction H, which can also be seen in FIG. 11 of the drawing, is arranged at the top instead of the arrangement at the bottom according to FIG. 1 of the drawing.

The telescopic suspension strut 43 shown in FIG. 2 of the drawing again shows a section II, which corresponds to the configuration according to the illustration in FIG. 2 of the drawing, since the second version of the telescopic suspension strut shown in FIG. 3 of the drawing also has a fluid passage 38 between the receiving chamber 37 and the receiving space 39 provided on the telescopic suspension strut 43, which again corresponds to the gap space 15 between the inner tube 2 and outer tube 3. The second version of the telescopic suspension strut 43 shown in FIG. 3 of the drawing therefore has the same advantages as those already explained above with reference to the telescopic suspension strut 1 shown in FIG. 1.

FIG. 4 of the drawing shows a sectional view of the outer tube 3 according to section IV-IV as shown in FIG. 2 of the drawing, whereby the slide bushing 28 shown in FIG. 2 of the drawing and the complete inner construction of the telescopic suspension fork leg 1 have been omitted for the sake of simplicity.

The outer pipe 3 has an inner circumferential surface 31 on which the slide bushing 28, which can be a hollow cylindrical body, as shown in FIG. 2 of the drawing, can be arranged. The outer pipe 3 has three equidistantly distributed fluid passages 38, each of which is angularly spaced at 120 degrees to each other and is circular-segment-shaped and has a total cross-sectional area which, in the design shown, is three times the cross-sectional area of the annular gap between the slide bushing and the outer circumferential surface of the inner pipe 2. This design ensures that a bypass channel or flow channel is made available to the fork oil accumulating in the receiving chamber 37 so that it can flow into the gap space 15 between outer tube 3 and inner tube 2 without any great flow resistance and thus the pressure distribution already described above and shown in FIG. 10 of the drawing is achieved. In the variant shown, the fluid outlets designed in the form of a groove 51, which is circular segment-shaped. This shape has the advantage of a lower notch effect and the associated lower influence on the strength of the outer pipe 3.

FIG. 5 of the drawing shows a perspective view of the outer tube 3 of the telescopic suspension fork leg 1, 43 with a fluid channel 38 shown on a contact surface 45 for receiving the slide bushing 28. Three fluid channels 38 are also provided in this version of the outer tube 3, of which only one fluid channel 38 is visible due to the selected representation.

FIG. 6 of the drawing shows a modified version of an outer tube 3, in which the fluid channel 38, through which the fork oil or damping fluid collected in the receiving chamber 37 can flow into the gap space 15 between outer tube 3 and inner tube 2, is of spiral or helical design and extends along a partial longitudinal extension of the outer tube 3. This fluid channel 38, which is also spiral or spiral-shaped in the form of a helix or spiral 52, ensures that no dynamic pressure is formed in the receiving chamber 37 and that the pressure conditions shown in reference to FIG. 10 of the drawing are achieved.

FIG. 7 of the drawing shows a perspective view of a slide bushing 28 with fluid channels 38 formed on its outer circumferential surface 46 and arranged at an angle to the longitudinal axis of the slide bushing 28, which is formed by a hollow cylindrical body.

Via these fluid channels 38 the fork oil accumulating in the receiving chamber 37 can flow off in the direction of the gap 15 between the inner tube 2 and the outer tube 3, so that the pressure conditions shown in FIG. 10 of the drawing and already explained above are again established.

The above mentioned motorcycle 18 is shown in FIG. 11 of the drawing. The motorcycle 18 has a telescopic suspension fork 47 which has two telescopic suspension fork legs 1 as shown in FIG. 1 of the drawing. The motorcycle 18 is an off-road sports motorcycle which can be used for example in motocross competitions and therefore has a telescopic fork which is subject to very high dynamic suspension movements. The motorcycle 18 has a front wheel 19 and a rear wheel 48 as well as a driver's saddle 49 and a drive engine 50, which in the version of the motorcycle 18 shown here is a four-stroke engine.

It is also an advantage on such an off-road sports motorcycle if the response of the telescopic suspension fork 47 does not change during a competition ride, as this also ensures that the rider of the motorcycle does not have to change his riding style.

FIG. 12 of the drawing shows three schematic perspective representations to explain the process of manufacturing the outer tube 3 of the telescopic suspension fork leg 1, 43 according to the invention by means of a non-cutting shaping process or non-cutting forming with simultaneous formation of the fluid passages or bypass channels or fluid channels already explained above.

As can be easily seen from the drawing and in particular from the upper illustration in FIG. 12, a tube body 53 and a tool 54 in the form of an inner mandrel 55 are first provided, which has stepped forming surfaces 56 on its outer circumference to form the diameter steps 57 of the outer tube 3 to be produced.

As can also be seen from FIG. 12, the inner mandrel 55 has 59 projections 60 on its central forming surface 59 arranged in the longitudinal direction and equally distributed at an angle in the circumferential direction, of which only one projection 60 is visible in FIG. 12 due to the perspective selected, with which the three fluid passages 38 shown in FIG. 4 of the drawing can be formed without cutting.

To do this, first prepare the tube body 53 to be formed into the outer tube 3 and the tool 54, as shown in the upper illustration in FIG. 12, and then insert the tool 54 into the front opening 61 of the tube body 53, as shown in the middle illustration in FIG. 12. In this process, both the diameter graduations 57 are formed on the tube body 53 and the groove-shaped fluid passages 38 are produced on the middle diameter graduation 62 without cutting, of which only one fluid passage 38 can be seen in the perspective selected in the lower illustration of FIG. 12.

The manufacturing process according to the invention is characterized by the fact that the outer tube 3 can be formed without cutting and at the same time the fluid passages 38 can be formed.

The telescopic suspension fork leg according to the invention and the telescopic suspension fork equipped with it are characterized by the advantages that, on the one hand, the problem of inflating the telescopic suspension fork or the telescopic suspension fork leg is eliminated and the response behavior of the telescopic suspension fork does not change even during highly dynamic movements while the vehicle equipped with it is moving. In addition, it has been shown that the continuous increase in friction of the telescopic suspension fork according to the invention is significantly lower during long operation compared to the known telescopic suspension fork, since there is a significantly improved oil circulation in the area of the sealing lip and the slide bushing and therefore any dirt particles do not remain in these contact zones between the sealing lip and the inner tube and the slide bushing and the inner tube, but are continuously flushed out.

The continuous circulation of the fork oil also ensures that the shear stresses occurring in the contact area and stressing the fork oil are reduced and therefore the aging process of the fork oil used is also slowed down, which in turn can be used to increase the intervals at which the fork oil is changed. The reduced shear stress also ensures that the fluid friction occurring in the shear gap is reduced and thus the frictional torque behaviour of the telescopic suspension fork leg according to the invention and the telescopic suspension fork equipped with it is reduced in comparison with the known telescopic suspension fork leg and the telescopic suspension fork equipped with it, which in turn ensures that the telescopic suspension fork according to the invention responds more sensitively to road unevenness than the known telescopic suspension fork.

With regard to features of the invention not further explained in detail above, explicit reference is made to the claims and the drawing.

### LIST OF REFERENCE SIGNS

1. telescopic suspension fork leg
2. inner pipe
3. outer tube
4. spring device
5. first chamber
6. second chamber
7. damping device
8. piston rod
9. piston
10. upper piston surface
11. lower piston surface
12. bore
13. damping tube
14. annular chamber
15. splitting room
16. clamping first
17. thru axle
18. motorcycle
19. front wheel
20. cover
21. cover
22. sliding sleeve
23. interior
24. sealing device
25. sealant
26. sealing lip
27. outer circumferential surface
28. slide bushing
29. radial shaft seal
30. body
31. inner circumferential surface
32. end range
33. jib
34. end range
35. spiral tension spring
36. outer circumferential surface
37. receiving chamber
38. fluid passage
39. recording room
40. sine wave
41. curve
42. curve
43. Telescopic suspension fork leg
44. annular gap
45. contact surface
46. outer circumferential surface
47. Telescopic suspension fork
48. rear wheel
49. driver saddle
50. drive motor
51. groove
52. helix, spiral
53. tube body
54. tool
55. internal mandrel
56. forming area
57. diameter gradations
58. diameter gradation
59. forming area
60. lead
61. opening
62. average diameter gradation
P double arrow A extension movement H high axis direction

1: A telescopic suspension fork leg (1, 43) comprising:
an inner tube (2);
an outer tube (3);
a damping device (7); and
a spring device (5), arranged inside a first chamber (5) in either the inner tube (2) or the outer tube (3), and supported in relation to a second chamber (6) formed by the damping device (7); and
wherein the telescopic suspension fork leg (1, 43) receives a damping fluid;
the damping device (7) comprising a piston (9) supported on a piston rod (8), the piston comprising an upper piston surface and a lower piston surface (10; 11);
the piston (9) displaceable within a damping tube (13) arranged largely concentrically to the inner tube (2);
the damping tube (13) is surrounded by an annular chamber (14) arranged concentrically to the damping tube (13); and
a gap space (15) formed between the inner tube (2) and the outer tube (3);
a slide bushing (28) radially surrounding the inner tube (2); and wherein the telescopic suspension fork leg (1, 43) further comprises:
a sealing device (24) radially surrounding the inner tube (2), which sealing device has at least one sealing means (25) supported on an outer circumferential surface (27) of the inner tube (2); and
a receiving chamber (37), for receiving damping fluid, between the sealing device (24) and the slide bushing (28); and
wherein the telescopic suspension fork leg (1, 43) has at least one fluid passage (38) between the receiving chamber (37) and a receiving space (39) on the telescopic suspension fork leg.

2: The telescopic suspension fork leg (1, 43) according to claim 1, wherein the receiving space (39) is defined by either the gap space (15) or one of the first chamber (5) or the second chamber (6).

3: The telescopic suspension fork leg (1, 43) according to claim 1, wherein the at least one fluid passage (38) is formed on the slide bushing (28) or the outer tube (3).

4: The telescopic suspension fork leg (1, 43) according to claim 1, wherein a hollow cylindrical body is provided radially between the slide bushing (28) and the outer tube (3), and the cylindrical body is provided with the at least one fluid passage (38).

5: The telescopic suspension fork leg (1, 43) according to claim 1, wherein the at least one fluid passage (38) extends into a region supporting the sealing means (25) relatively against the outer circumferential surface (27) of the inner tube (2).

6: The telescopic suspension fork leg (1, 43) according to claim 1, wherein the at least one fluid passage (38) is formed by a groove (51) fluidically connecting the receiving chamber (37) and the receiving space (39).

7: The telescopic suspension fork leg (1, 43) according to claim 1, wherein the at least one fluid passage (38) is arranged on an inner circumferential surface (31) of the outer tube (3), and extends between the gap space (15) and the receiving chamber (37).

8: The telescopic suspension fork leg (1, 43) according to claim 1, wherein the at least one fluid passage (38) is arranged on an outer peripheral surface (46) of the slide bushing (28), and extends between the gap space (15) and the receiving chamber (37).

9: The telescopic suspension fork leg (1, 43) according to claim 1, wherein the at least one fluid passage (38) is in the form of a groove (51) extending between the receiving chamber (37) and the receiving space (39), which groove extends substantially parallel, or at an angle, to a portion of a longitudinal central axis of the telescopic suspension fork leg (1, 43), and is defined on an inner peripheral surface (31) of the outer tube (3) or on an outer peripheral surface (46) of the slide bushing (28).

10: The telescopic suspension fork leg (1, 43) according to claim 1, wherein the at least one fluid passage (38) is a groove extending between the receiving chamber (37) and the receiving space (39), which groove is formed on an inner peripheral surface (31) of the outer tube (3) or on an outer peripheral surface (27) of the sliding bush (28), and in the shape of a helix (52) extending helically around a portion of a longitudinal central axis of the telescopic suspension fork leg.

11: The telescopic suspension fork leg (1, 43) according to claim 1, wherein the at least one fluid passage (38) has a cross-sectional area corresponding at least to an area of an annular gap area between the inner tube (2) and the slide bushing (28).

12: The telescopic suspension fork leg (1, 43) according to claim 11, wherein the cross-sectional area corresponds to a value in the range of from one to five times the area of the annular gap.

13: The telescopic suspension fork leg (1, 43) according to claim 1, wherein the at least one fluid passage (38) comprises at least two fluid passages (38) arranged in a circumferential direction of an outer circumferential surface of the slide bushing (28) or an inner circumferential surface of the outer tube (3).

14: The telescopic suspension fork leg (1, 43) according to claim 13, wherein the fluid passages (38) are evenly distributed in a circumferential direction.

15: The telescopic suspension fork leg (1, 43) according to claim 1, wherein the at least one fluid passage (38) defines in a cross-sectional view a shape of a segment of a circle.

16: The telescopic suspension fork leg (1, 43) according to claim 15, comprising a suspension fork (47) with two telescopic suspension fork legs (1, 43), wherein the telescopic suspension fork legs (1, 43) are arranged such that the damping device (7) is arranged below or above the first chamber (5) receiving the spring device (4).

17: A motorcycle (48) having a front wheel (19), a rear wheel (48), a rider's saddle (49), and a drive motor (50), comprising a telescopic suspension fork (47) according to claim 16.

18: A method of manufacturing a telescopic suspension fork leg (1, 43) comprising at least one fluid passage (38) on an inner peripheral surface along a longitudinal direction of an outer tube (3), comprising the steps of:
providing a tubular pipe body (53) forming an outer pipe (3);
inserting a mandrel tool (55) supporting the pipe body (53) on the inside and having at least one projecting outer contour (60) into the pipe body (53) to near the at least one fluid passage (38) to be formed;
moving the tubular body (53) and the mandrel tool (55) relative to each other such that the at least one projecting outer contour (60) forms, by shaping without cutting, the at least one fluid passage (38) on an inner circumferential surface of the tubular pipe body (53).

19: The telescopic suspension fork leg (1, 43) according to claim 1,
wherein the at least one fluid passage (38) is formed on the slide bushing (28) and the outer tube (3).

20: The telescopic suspension fork leg (1, 43) according to claim 1, wherein the at least one fluid passage (38) is in the form of a groove (51) extending between the receiving chamber (37) and the receiving space (39), which groove extends parallel, or at an angle, to a portion of a longitudinal central axis of the telescopic suspension fork leg (1, 43), and is defined on an inner peripheral surface (31) of the outer tube (3) and on an outer peripheral surface (46) of the slide bushing (28).

21: The telescopic suspension fork leg (1, 43) according to claim 11, wherein the cross-sectional area corresponds to a value in the range of from one to three times the area of the annular gap.
